(19) United States
(12) Patent Application Publication
(10) Pub. No.: US 2026/0252529 A1
(43) Pub. Date: Aug. 27, 2026

(54) METHODS AND APPARATUSES FOR CREATING TABLESPACE, STORAGE MEDIA, AND ELECTRONIC DEVICES

(71) Applicant: Beijing Oceanbase Technology Co., Ltd., Beijing (CN)

(72) Inventors: Zhifeng YANG, Hangzhou (CN); Quanwei WAN, Hangzhou (CN); Mingqiang ZHUANG, Hangzhou (CN)

(21) Appl. No.: 18/871,060

(22) PCT Filed: Aug. 10, 2023
(86) PCT No.: PCT/CN2023/112157

§ 371 Date: Dec. 2, 2024

(30) Foreign Application Priority Data
Oct. 17, 2022 (CN) 202211269001.7

(51) Int. Cl. G06F 16/11

(52) U.S. Cl. CPC G06F 16/122

(57) ABSTRACT

Methods and apparatuses for creating a tablespace, storage media, and electronic devices are disclosed. The method includes: receiving a tablespace creation instruction; determining, in a distributed database based on an identifier of a server carried in the creation instruction, the server corresponding to the identifier as a specified server; based on a capacity for creating a tablespace carried in the creation instruction and a remaining storage space of the specified server, determining a storage space whose total capacity is the capacity; creating a virtual file based on the determined storage space; and creating a tablespace including the virtual file.

### TECHNICAL FIELD

This specification relates to the field of computer technologies, and in particular, to methods and apparatuses for creating a tablespace, storage media, and electronic devices.

### BACKGROUND

With the development of information technologies, databases are widely applied. With wide application of the databases, there are more data files corresponding to tables, indexes, etc. in the databases. To facilitate management of data files, tablespaces may be created for the databases. The tablespace is a logical structure, and is used to manage storage spaces of the data files. Compared with the physical structure, the logical structure can facilitate the server to manage data files. For example, the server may transfer data between databases by using tablespaces, and there is no need to first download data of one database and then insert the data into another database. The server may copy all data of tablespaces of a database, to transfer the data from the database to another database.

Currently, distributed databases that use a new type of share-nothing architecture are relatively widely applied. However, the distributed database of the share-nothing architecture is a database that includes servers serving as nodes, data of the distributed database of the share-nothing architecture is stored in different nodes, and the storage space of each node is not shared.

Therefore, how to create a tablespace on the distributed database of the share-nothing architecture is an urgent problem to be solved.

### SUMMARY

This specification provides methods and apparatuses for creating a tablespace, storage media, and electronic devices, to partially resolve the above-mentioned problem.

This specification uses the following technical solutions. This specification provides a method for creating a tablespace. The method is applied to a distributed database and includes: receiving a tablespace creation instruction, where the creation instruction carries a capacity of a tablespace that needs to be created and an identifier of a server on which a storage space constituting the capacity is located; determining, in the distributed database, a server corresponding to each identifier as a specified server; determining, based on the capacity, a storage space whose total capacity is the capacity from a remaining storage space of each specified server; creating a virtual file of the capacity based on the determined storage space; and creating a tablespace including the virtual file, where the tablespace is used to manage the virtual file included in the tablespace, and the virtual file is used to write data.

Optionally, before the virtual file of the capacity is created, the method includes: determining that the remaining storage space of each specified server is not less than a predetermined unit capacity.

Optionally, the creating a virtual file of the capacity based on the determined storage space specifically includes: determining, based on the capacity and a predetermined unit capacity, a specified quantity of sub-files whose sizes are all the predetermined unit capacity; circularly writing each sub-file into the remaining storage space of each specified server until all the specified quantity of sub-files are written; and creating the virtual file including the sub-files.

Optionally, the circularly writing each sub-file into the remaining storage space of each specified server specifically includes: sorting each specified server to obtain a specified server sequence; for each specified server, sequentially using the specified server as a to-be-written server; determining whether a remaining storage space of the to-be-written server is not less than the unit capacity; and if yes, writing the sub-file into the remaining storage space of the to-be-written server; otherwise, reusing a next specified server of the specified server as the to-be-written server based on the specified server sequence until the sub-file is written.

Optionally, the method further includes: for each sub-file, determining a logical address of the sub-file in the virtual file, using a specified server on which the sub-file is located as a target server, and determining a physical address of the sub-file in the target server as a physical address corresponding to the sub-file; and establishing a mapping relationship between the logical address of the sub-file and the physical address corresponding to the sub-file.

Optionally, the method further includes: receiving a deletion instruction, where the deletion instruction carries an identifier of a server that needs to be deleted; determining the server corresponding to the identifier carried in the deletion instruction as a to-be-deleted server; using each virtual file created based on a storage space of the to-be-deleted server as a to-be-deleted virtual file; for each to-be-deleted virtual file, moving data in the to-be-deleted virtual file to a tablespace that does not include any to-be-deleted virtual file, and deleting the to-be-deleted virtual file; and deleting the identifier of the to-be-deleted server from a server identifier list of the distributed database, where the server identifier list includes identifiers of all servers constituting the distributed database.

This specification provides an apparatus for creating a tablespace, where the apparatus is used in a distributed database and includes: a receiving module, configured to receive a tablespace creation instruction, where the creation instruction carries a capacity of a tablespace that needs to be created and an identifier of a server on which a storage space constituting the capacity is located; a first determining module, configured to determine, in the distributed database, a server corresponding to each identifier as a specified server; a second determining module, configured to determine, based on the capacity, a storage space whose total capacity is the capacity from a remaining storage space of each specified server; a first creation module, configured to create a virtual file of the capacity based on the determined storage space; and a second creation module, configured to create a tablespace including the virtual file, where the tablespace is used to manage the virtual file included in the tablespace, and the virtual file is used to write data.

Optionally, before creating the virtual file of the capacity, the first creation module is further configured to determine that the remaining storage space of each specified server is not less than a predetermined unit capacity.

Optionally, the first creation module is specifically configured to: determine, based on the capacity and a predetermined unit capacity, a specified quantity of sub-files whose sizes are all the predetermined unit capacity; circularly write each sub-file into the remaining storage space of each specified server until all the specified quantity of sub-files are written; and create the virtual file including the sub-files.

Optionally, the first creation module is specifically configured to: sort each specified server to obtain a specified server sequence; for each specified server, sequentially use the specified server as a to-be-written server; determine whether a remaining storage space of the to-be-written server is not less than the unit capacity; and if yes, write the sub-file into the remaining storage space of the to-be-written server; otherwise, reuse a next specified server of the specified server as the to-be-written server based on the specified server sequence until the sub-file is written.

Optionally, the apparatus further includes a mapping module, configured to: for each sub-file, determine a logical address of the sub-file in the virtual file, use a specified server on which the sub-file is located as a target server, and determine a physical address of the sub-file in the target server as a physical address corresponding to the sub-file; and establish a mapping relationship between the logical address of the sub-file and the physical address corresponding to the sub-file.

Optionally, the apparatus further includes a deletion module, configured to: receive a deletion instruction, where the deletion instruction carries an identifier of a server that needs to be deleted; determine the server corresponding to the identifier carried in the deletion instruction as a to-be-deleted server; use each virtual file created based on a storage space of the to-be-deleted server as a to-be-deleted virtual file; for each to-be-deleted virtual file, move data in the to-be-deleted virtual file to a tablespace that does not include any to-be-deleted virtual file, and delete the to-be-deleted virtual file; and delete the identifier of the to-be-deleted server from a server identifier list of the distributed database, where the server identifier list includes identifiers of all servers constituting the distributed database.

This specification provides a non-transitory computer-readable storage medium. The storage medium stores a computer program, and when the computer program is executed by a processor, the method for creating a tablespace is implemented.

This specification provides an electronic device, including a memory, a processor, and a computer program stored in the memory and capable of running on the processor. When the processor executes the computer program, the method for creating a tablespace is implemented.

The above-mentioned at least one technical solution used in this specification can achieve the following beneficial effects: In the method for creating a tablespace provided in this specification, a tablespace creation instruction is received; based on an identifier of a server carried in the creation instruction, the server corresponding to the identifier is determined as a specified server in a distributed database; based on a capacity for creating a tablespace carried in the creation instruction and a remaining storage space of the specified server, a storage space whose total capacity is the capacity is determined, a virtual file is created based on the determined storage space; and a tablespace including the virtual file is created.

It can be learned from the above-mentioned method that in this method, based on the remaining storage space of the specified server in the distributed database and the capacity of the tablespace that needs to be created, the storage space whose total capacity is the capacity is determined, and the virtual file is created based on the determined storage space, so that a remaining storage space of each originally distributed specified server can be unified by using the virtual file, and the tablespace including the virtual file can be created, to implement a cross-server tablespace function in a share-nothing architecture. The virtual file included in the tablespace can be managed by using the tablespace, and data can be written into the virtual file.

### BRIEF DESCRIPTION OF DRAWINGS

The accompanying drawings described here are used to provide a further understanding of this specification, and constitute a part of this specification. Example embodiments of this specification and descriptions of the embodiments are used to explain this specification, and do not constitute an inappropriate limitation on this specification.

FIG. 1 is a schematic flowchart illustrating a method for creating a tablespace, according to this specification;

FIG. 2 is a schematic diagram illustrating a process of creating a virtual file, according to this specification;

FIG. 3 is a schematic flowchart illustrating tablespace expansion, according to this specification;

FIG. 4 is a schematic diagram illustrating a process of creating an expansion virtual file, according to this specification;

FIG. 5 is a schematic flowchart illustrating deleting a node in a distributed database, according to this specification;

FIG. 6 is a schematic diagram illustrating an apparatus for creating a tablespace, according to this specification; and

FIG. 7 is a schematic diagram illustrating an electronic device corresponding to FIG. 1, according to this specification.

### DESCRIPTION OF EMBODIMENTS

To make the objectives, technical solutions, and advantages of this specification clearer, the following clearly and comprehensively describes the technical solutions of this specification with reference to specific embodiments and accompanying drawings of this specification. Clearly, the described embodiments are merely some but not all of the embodiments of this specification. All other embodiments obtained by a person of ordinary skill in the art based on embodiments of this specification without creative efforts shall fall within the protection scope of this specification.

The following describes in detail the technical solutions provided in the embodiments of this specification with reference to the accompanying drawings.

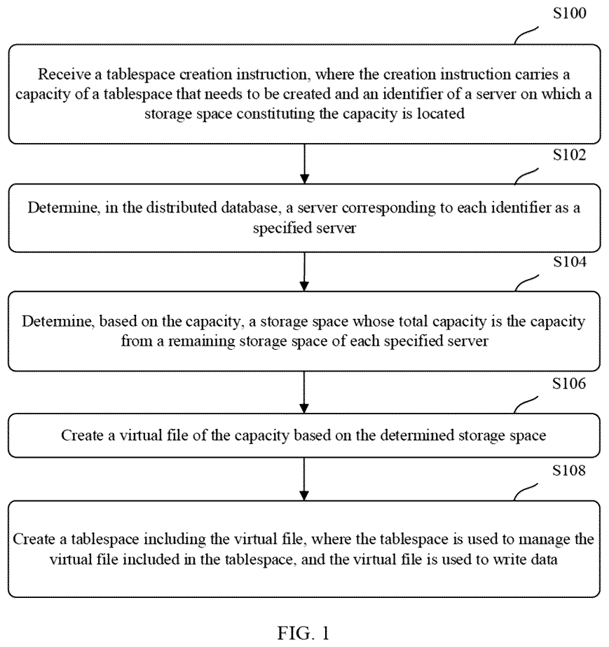

FIG. 1 is a schematic flowchart illustrating a method for creating a tablespace, according to this specification, where step S100 to step S108 are included.
S100: Receive a tablespace creation instruction, where the creation instruction carries a capacity of a tablespace that needs to be created and an identifier of a server on which a storage space constituting the capacity is located.

Data of a distributed database in a share-nothing architecture is stored in a plurality of different servers serving as nodes, and storage spaces of the servers are not shared. Therefore, the tablespace cannot be directly created.

Based on this, in this specification, a device for creating the tablespace receives the tablespace creation instruction, where the creation instruction carries the capacity of the tablespace that needs to be created and the identifier of the server on which the storage space constituting the capacity is located. The device for creating the tablespace may be a server that serves as a common node in the distributed database, or may be a server that serves as a management node in the distributed database. For ease of description, the following uses a server that serves as a common node as an execution body for description. The creation instruction may be sent by a client to the server, so that the server creates the tablespace based on the creation instruction. The identifier that is of the server on which the storage space constituting the capacity is located and that is carried in the creation instruction is actually an identifier of a server that is expected to be covered by the tablespace created in the share-nothing architecture. Subsequently, based on the identifier, the server corresponding to the identifier may be determined in the distributed database as the specified server for creating the tablespace.
S102: Determine, in the distributed database, a server corresponding to each identifier as the specified server.

In the distributed database, the server corresponding to each identifier carried in the creation instruction is used as the specified server, where the specified server may be the server for creating the tablespace, or may be a server serving as a common node in the distributed database.

For example, a creation instruction received by server 1 is: CREATE VIRTUAL FILE ‘data1.ob’ ON ‘/data/1/data1@server1; /data/1/data1@server2; /data/1/data1@server3;’ SIZE 3G; CREATE TABLESPACE tablespace1 DATAFILE ‘/data1.ob’. Identifiers of servers carried in the creation instruction are server1, server2, and server3, and server 1 is the device for creating the tablespace. In this case, server 1 determines, in the distributed database, a server corresponding to each identifier as the specified server. The server corresponding to server1 is server 1, the server corresponding to server2 is server 2, and the server corresponding to server3 is server 3. That is, server 1, server 2, and server 3 are used as the specified servers.
S104: Determine, based on the capacity, a storage space whose total capacity is the capacity from a remaining storage space of each specified server.

The server determines, based on the capacity, the storage space whose total capacity is the capacity from the remaining storage space of each specified server. Specifically, when the capacity is not greater than a total capacity of the remaining storage space of each specified server, the storage space whose total capacity is the capacity is determined from the remaining storage space of each specified server.

The above-mentioned example continues to be used. The capacity that is carried in the creation instruction and received by server 1 and that is of the tablespace that needs to be created is 3 G. It is assumed that remaining storage spaces of server 1, server 2, and server 3 are 1 G, 2 G, and 4 G respectively. When the capacity is not greater than a total capacity of the remaining storage space of each specified server, a storage space whose total capacity is the capacity is determined from the remaining storage space of each specified server. In other words, the total capacity of the remaining storage spaces of server 1, server 2, and server 3 is 7 G, and is not less than the capacity 3 G, and the storage space whose total capacity is the capacity is determined from the remaining storage space of each specified server. The storage space of 3 G is determined from the remaining storage spaces of server 1, server 2, and server 3. A proportion of the remaining storage space of each specified server to 3G may be the same or may be different. 3 G may be equally divided, and server 1, server 2, and server 3 each only need to provide a storage space of 1 G from the remaining storage space. In this example, the remaining storage space of server 1 is only 1 G. Therefore, server 1 may provide a storage space of 1 G at most. If server 1 provides the storage space of 1 G, the remaining 2 G may be randomly provided by the remaining storage spaces of server 2 and server 3, provided that the storage space of 3G can be determined from the remaining storage spaces of server 1, server 2, and server 3.
S106: Create a virtual file of the capacity based on the determined storage space.

Based on the determined storage space, the server creates the virtual file whose capacity is the capacity carried in the creation instruction. Specifically, to ensure that the server (namely, the specified server) expected to be covered by the tablespace created in the share-nothing architecture is covered, each specified server needs to have an enough remaining storage space. The server may first determine whether the remaining storage space of each specified server is not less than a predetermined unit capacity. If not, it indicates that at least one specified server does not have an enough storage space. The server cannot create any unit of the virtual file on the specified server that does not have an enough storage space, and the specified server cannot be covered by a subsequently created tablespace. If yes, based on the determined storage space, the capacity, and the predetermined unit capacity, the capacity is divided based on the predetermined unit capacity, and a value obtained by rounding the capacity and the predetermined unit capacity is used as a specified quantity. The specific quantity of sub-files whose sizes are all the predetermined unit capacity are determined, and each sub-file is cyclically written into the remaining storage space of each specified server until all the specified quantity of sub-files are written. The server creates the virtual file including the sub-files.

When each sub-file is cyclically written into the remaining storage space of each specified server, the server sorts each specified server to obtain a specified server sequence; for each specified server, sequentially uses the specified server as a to-be-written server; determines whether a remaining storage space of the to-be-written server is not less than the predetermined unit capacity; and if yes, writes the sub-file into the remaining storage space of the to-be-written server. Otherwise, a next specified server of the specified server is reused as the to-be-written server based on the specified server sequence until the sub-file is written.

When determining the storage space whose total capacity is the capacity from the remaining storage space of each specified server in step S104, the storage space whose total capacity is the capacity can be determined from the remaining storage space of each specified server only when the capacity is not greater than the total capacity of the storage space remaining of each specified server. However, the device for creating the tablespace may only learn that the total capacity of the remaining storage space of each specified server is not less than the capacity, but cannot learn a specific remaining storage space of each specified server (except the device for creating the tablespace). However, each server expected to be covered by the tablespace created in the share-nothing architecture needs to be covered, that is, each specified server corresponding to the identifier of the server carried in the creation instruction can be covered. Therefore, each specified server needs to have a sufficient remaining storage space. The device for creating the tablespace does not know whether each specified server has an enough remaining storage space, nor whether each specified server can be covered. Therefore, there may be a case in which a specified server does not have an enough remaining storage space, and the specified server is not covered In this case, the device for creating the tablespace cannot create a virtual file of the capacity.

Therefore, before the virtual file of the capacity is created based on the determined storage space in step S106, to determine that each specified server has an enough remaining storage space, the server needs to determine that the remaining storage space of each specified server is not less than the predetermined unit capacity. Therefore, the capacity may be divided based on the predetermined unit capacity, the specified quantity of sub-files whose sizes are all the predetermined unit capacity are determined, and each sub-file is circularly written into the remaining storage space of each specified server until all the specified quantity of sub-files are written. Each sub-file is circularly written into the remaining storage space of each specified server, so that at least one written sub-file may exist in the remaining storage space of each specified server, and then the virtual file including all the sub-files is created. When a sub-file is written into a specified server, if a remaining storage space of the specified server is insufficient, it indicates that the remaining storage space of the specified server is less than the predetermined unit capacity, the sub-file cannot be written into the remaining storage space of the specified server, and the remaining storage space of the specified server is fully filled. The sub-file needs to be written into a remaining storage space of a next specified server of the specified server based on the server sequence. For a specified server, if any sub-file is not successfully written into the specified server, it indicates that a remaining storage space of the specified server is less than the predetermined unit capacity, the specified server does not have an enough remaining storage space, and the specified server is not covered.

For each sub-file, a specified server on which the sub-file is located is used as a target server, a physical address of the sub-file in the target server is determined as a physical address corresponding to the sub-file, and a mapping relationship between the logical address of the sub-file in the virtual file and the physical address corresponding to the sub-file is established.

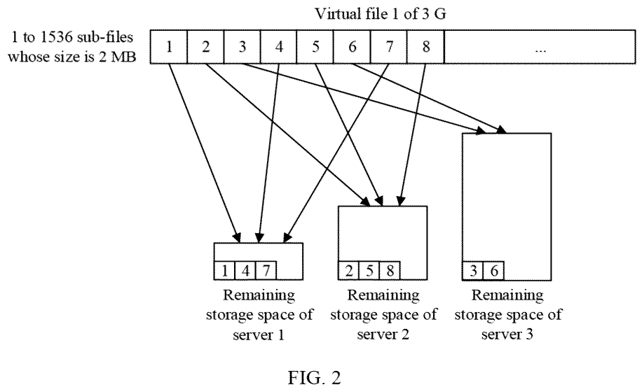

The above-mentioned example continues to be used. Refer to FIG. 2. FIG. 2 is a schematic diagram illustrating a process of creating a virtual file, according to this specification. It is assumed that the predetermined unit capacity of server 1 is 2 MB, and the remaining storage spaces of server 1, server 2, and server 3 are 1 G, 2 G, and 4 G respectively. Because server 1 can only learn that the remaining storage space of server 1 is 1 G, and cannot learn a remaining storage space of another specified server, namely, the 2 G remaining storage space of server 2 and the 3 G remaining storage space of server 3. However, each specified server (namely, server 1, server 2, and server 3) needs to be covered. In other words, each specified server needs to have an enough remaining storage space. Therefore, server 1 may write a sub-file of the predetermined unit capacity into the remaining storage space of each specified server, to detect whether the remaining storage space of each specified server is not less than the predetermined unit capacity. Server 1 may divide the capacity of 3 G based on a unit capacity 2 MB; use, as a specified quantity, a value 1536 obtained by rounding a quotient of 3 G and 2 MB; and determine 1536 sub-files whose sizes are all 2 MB. Server 1 sorts each specified server (namely, server 1, server 2, and server 3). It is assumed that a specified server sequence obtained through sorting is server 1, server 2, and server 3. Based on the specified server sequence, sub-file 1 to sub-file 1536 are cyclically written into the remaining storage spaces of server 1, server 2, and server 3 until all the 1536 sub-files (namely, sub-file 1 to sub-file 1536) are written. For example, when server 1 is used as the to-be-written server, and sub-file 1 is written into the remaining storage space of server 1, the remaining storage space of server 1 is 1 G, and is not less than the predetermined unit capacity 2 MB, and sub-file 1 is written into the remaining storage space of the to-be-written server (namely, server 1). However, when a sub-file is written into a specified server, for example, when sub-file 100 is written into the remaining storage space of server 1, if the remaining storage space of server 1 is insufficient, it indicates that the remaining storage space of server 1 is less than the predetermined unit capacity, sub-file 100 cannot be written into the remaining storage space of server 1, and the remaining storage space of server 1 is fully filled. Sub-file 100 needs to be written into a remaining storage space of a next specified server (namely, server 2) of server 1 based on the server sequence. After all the 1536 sub-files are written, server 1 creates a virtual file including sub-file 1 to sub-file 1536, namely, virtual file 1, that is, data1.ob in the creation instruction.

Then, it is assumed that the remaining storage spaces of server 1, server 2, and server 3 are 1 G, 1 MB, and 4 G, respectively. Server 1 circularly writes sub-file 1 to sub-file 1536 into the remaining storage spaces of server 1, server 2, and server 3 based on the specified server sequence until all the 1536 sub-files (namely, sub-file 1 to sub-file 1536) are written. It is assumed that sub-file 2 is written into the remaining storage space of server 2. The remaining storage space of server 2 is 1 MB, and is less than 2 MB. Sub-file 2 cannot be written into the remaining storage space of server 2. Sub-file 2 may be written into a next server of server 2, namely, server 3, based on the specified server sequence.

However, for a specified server, for example, server 2, when a sub-file fails to be written into server 2, it may be determined whether a sub-file has been successfully written into server 2 before. If no sub-file has been successfully written into server 2, it indicates that the remaining storage space of server 2 is less than the predetermined unit capacity 2 MB, the server 2 has no enough remaining storage space, and server 2 is not covered. In this case, server 1 cannot create a virtual file with the capacity of 3 G.

For each sub-file, the specified server on which the sub-file is located is used as the target server, the physical address of the sub-file in the target server is determined as the physical address corresponding to the sub-file, and the mapping relationship between the logical address of the sub-file in the virtual file and the physical address corresponding to the sub-file is established. That is, it is assumed that logical addresses of sub-file 1 to sub-file 1536 in the virtual file are respectively 1, 2, 3, . . . , 1535, and 1536. For sub-file 1 to sub-file 1536, a logical address of sub-file 1 in the virtual file is determined to be 1, and a server on which sub-file 1 is located, namely, server 1, is used as the target server, to determine a physical address of sub-file 1 in server 1, and establish a mapping relationship between logical address 1 of sub-file 1 and the physical address of sub-file 1 in server 1 (FIG. 2 shows only the logical address of the sub-file, and does not show a physical address of each sub-file stored in the server). For other sub-files 2 to 1536, a mapping relationship between a logical address of each sub-file and a physical address corresponding to each sub-file is established in the above-mentioned method.
S108: Create a tablespace including the virtual file, where the tablespace is used to manage the virtual file included in the tablespace, and the virtual file is used to write data.

The server creates the tablespace including the virtual file, manage the virtual file included in the tablespace by using the tablespace, and may write data into the virtual file. The above-mentioned example continues to be used. Server 1 creates a tablespace including virtual file 1, namely, tablespace 1, that is, the tablespace1 in the creation instruction.

It can be learned from the above-mentioned method that in this method, the storage space whose total capacity is the capacity is determined based on the remaining storage space of the specified server in the distributed database and the capacity of the tablespace that needs to be created. The storage space of each specified server in the share-nothing architecture is not shared, only the specified server knows the remaining storage space of the specified server itself, each server expected to be covered by the tablespace created in the share-nothing architecture needs to be covered, and each specified server in the creation instruction needs to have an enough remaining storage space. Therefore, based on the determined storage space, it is determined that the remaining storage space of each specified server is not less than the predetermined unit capacity, the capacity is divided into a specified quantity of sub-files based on the predetermined unit capacity, and each sub-file is circularly written into the storage space of each specified server until all the specified quantity of sub-files are written. The virtual file including all the sub-files is created, and sub-files exist in the remaining storage space of each specified server. The virtual file including the sub-files unifies the remaining storage space of each distributed specified server, so that the tablespace including the virtual file may be created, to implement a cross-server tablespace function in the share-nothing architecture. The virtual file included in the tablespace can be managed by using the tablespace, and data can be written into the virtual file.

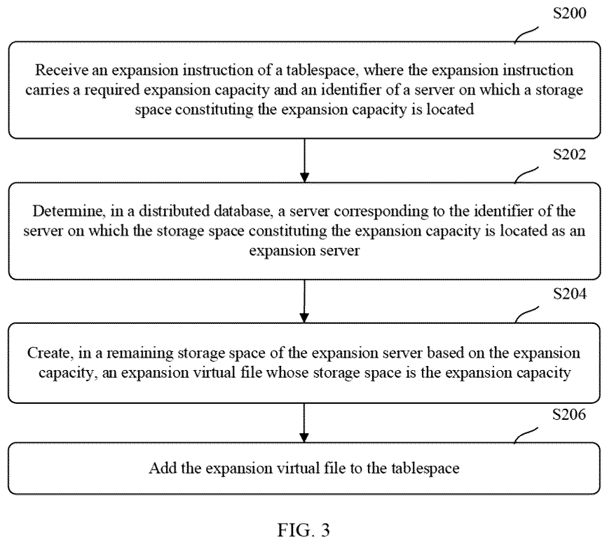

In the embodiments of this specification, when a tablespace in a distributed database is expanded, a virtual file needs to be created based on a remaining storage space of a server that serves as a node in the distributed database, and the virtual file needs to be added to the tablespace that needs to be expanded, as shown in FIG. 3. FIG. 3 is a schematic flowchart illustrating tablespace expansion, according to this specification, where step S200 to step S206 are included.
S200: Receive an expansion instruction of the tablespace, where the expansion instruction carries a required expansion capacity and an identifier of a server on which a storage space constituting the expansion capacity is located.
S202: Determine, in the distributed database, a server corresponding to the identifier of the server on which the storage space constituting the expansion capacity is located as an expansion server.

The server receives the expansion instruction of the tablespace. In the distributed database, the server determines the server corresponding to the identifier of the server on which the storage space constituting the expansion capacity is located as the expansion server. The expansion server may be a server that already exists in the distributed database as a common node, or may be a server newly added to the distributed database as a node.

For example, an expansion instruction of a tablespace received by server 1 is: CREATE VIRTUAL FILE ‘/data2.ob’ ON ‘/data/1/data2@server3; /data/1/data2@server4; ’SIZE 1G; ALTER TABLESPACE tablespace1 ADD DATAFILE ‘/data2.ob’. Identifiers of servers carried in the expansion instruction are server3 and server4. Server 1 determines, in the distributed database, the server corresponding to the identifier of the server on which the storage space constituting the expansion capacity is located as the expansion server. The server corresponding to server3 is server 3, and the server corresponding to server4 is server 4. In other words, server 3 and server 4 are used as the expansion servers. Server 3 is a server that already exists in the distributed database, and server 4 is a server newly added to the distributed database.
S204: Create, in a remaining storage space of the expansion server based on the expansion capacity, an expansion virtual file whose storage space is the expansion capacity.

The server creates, in the remaining storage space of the expansion server based on the expansion capacity, the expansion virtual file whose storage space is the expansion capacity. A specific process of creating the expansion virtual file is basically the same as step S104 and step S106 in the method shown in FIG. 1. Details are omitted here for simplicity

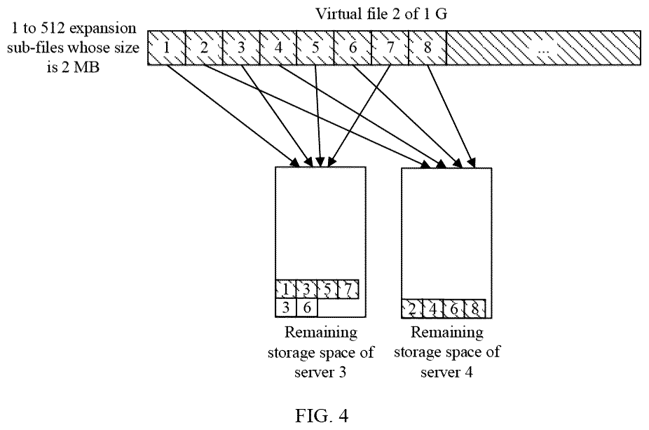

The above-mentioned example continues to be used. With reference to the examples in step S104 and step S106 in the method shown in FIG. 1, the process is shown in FIG. 4. FIG. 4 is a schematic diagram illustrating a process of creating an expansion virtual file, according to this specification. FIG. 4 shows only logical addresses of sub-files, and does not show a physical address of each sub-file stored in the server. It is assumed that remaining storage spaces of server 3 and server 4 each are 1 G, and the predetermined unit capacity is 2 MB. Based on the examples in step S104 and step S106 in the method described in FIG. 1, server 1 creates, in the remaining storage spaces of the expansion servers (namely, server 3 and server 4) based on the expansion capacity of 1 G, an expansion virtual file whose storage space is 1 G, namely, virtual file 2, that is, data2.ob in the expansion instruction.
S206: Add the expansion virtual file to the tablespace.

The server adds the expansion virtual file to the tablespace. The above-mentioned example continues to be used. Server 1 adds virtual file 2 to tablespace 1 created according to the method shown in FIG. 1, where tablespace 1 includes virtual file 1 and virtual file 2, and a capacity of tablespace 1 changes from original 3 G (namely, a capacity of virtual file 1) to 4 G (namely, a sum of the 3 G capacity of virtual file 1 and the 1 G capacity of virtual file 2).

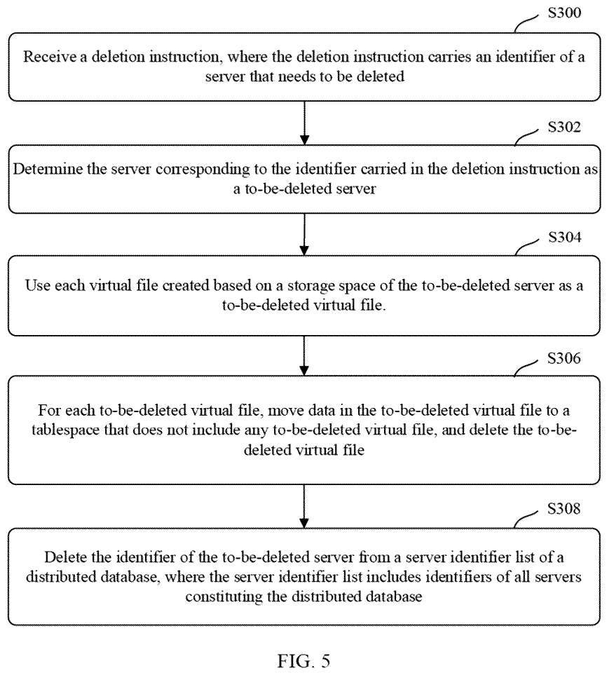

In the embodiments of this specification, when scaling a distributed database, that is, deleting an identifier of a server from a server identifier list of the distributed database, each virtual file created based on a storage space of the to-be-deleted server needs to be first transferred, and then the identifier of the to-be-deleted server is deleted from the server identifier list of the distributed database, as shown in FIG. 5. FIG. 5 is a schematic flowchart illustrating deleting a node in a distributed database, according to this specification, where step S300 to step S308 are included.
S300: Receive a deletion instruction, where the deletion instruction carries an identifier of a server that needs to be deleted.
S302: Determine the server corresponding to the identifier carried in the deletion instruction as a to-be-deleted server.
S304: Use each virtual file created based on a storage space of the to-be-deleted server as a to-be-deleted virtual file.

The server determines, based on the identifier that is of the to-be-deleted server and that is carried in the deletion instruction, the corresponding server as the to-be-deleted server, and uses each virtual file created based on the storage space of the to-be-deleted server as the to-be-deleted virtual file. The above-mentioned example continues to be used. It is assumed that the storage space of server 3 includes the sub-files (namely, sub-file 1 to sub-file 1536 that form the virtual file in the method shown in FIG. 1) of virtual file 1 and the sub-files (namely, the expansion sub-files in the method shown in FIG. 3) of virtual file 2 (namely, the virtual file formed by expansion sub-file 1 to expansion sub-file 512 in the method shown in FIG. 3). An identifier carried in the deletion instruction is 3, and a server corresponding to identifier 3 is server 3. Server 3 is used as the to-be-deleted server, and each virtual file created based on the storage space of server 3 is used as the to-be-deleted virtual file, that is, virtual file 1 and virtual file 2 are used as to-be-deleted virtual files.
S306: For each to-be-deleted virtual file, move data in the to-be-deleted virtual file to a tablespace that does not include any to-be-deleted virtual file, and delete the to-be-deleted virtual file.

For each to-be-deleted virtual file, the server moves the data in the to-be-deleted virtual file to the tablespace that does not include any to-be-deleted virtual file, and deletes the to-be-deleted virtual file. The tablespace that does not include any to-be-deleted virtual file may be a tablespace that exists in the distributed database and does not include any to-be-deleted virtual file, or may be a newly created tablespace. The above-mentioned example continues to be used. It is assumed that tablespace 1 that includes virtual file 1 and virtual file 2 and tablespace 2 that does not include virtual file 1 and virtual file 2 are in the distributed database. For each to-be-deleted virtual file, data in the to-be-deleted virtual file is moved to the tablespace that does not include any to-be-deleted virtual file, and the to-be-deleted virtual file is deleted. In other words, server 1 moves data in virtual file 1 and virtual file 2 to the tablespace that does not include any to-be-deleted virtual file (namely, virtual file 1 and virtual file 2), namely, tablespace 2, and deletes virtual file 1 and virtual file 2.
S308: Delete the identifier of the to-be-deleted server from a server identifier list of the distributed database, where the server identifier list includes identifiers of all servers constituting the distributed database.

The server deletes the identifier of the to-be-deleted server from the server identifier list of the distributed database, where the server identifier list includes the identifiers of all the servers constituting the distributed database. The above-mentioned example continues to be used. It is assumed that servers constituting the distributed database includes server 1, server 2, server 3, server 4, and server 5, and the server identifier list is 1, 2, 3, 4, and 5. Server 1 deletes identifier 3 corresponding to the to-be-deleted server (namely, server 3) in the above-mentioned example from the server identifier list, and the server identifier list after deletion is 1, 2, 4, and 5. In this case, servers constituting the distributed database change to server 1, server 2, server 4, and server 5.

In the embodiments of this specification, for each server that serves as a node in a distributed database, when the server is crashed, each sub-file in a storage space of the server is unavailable, and each sub-file in a storage space of another server is not affected. After the server is restored, each sub-file in the storage space of the server may continue to be used.

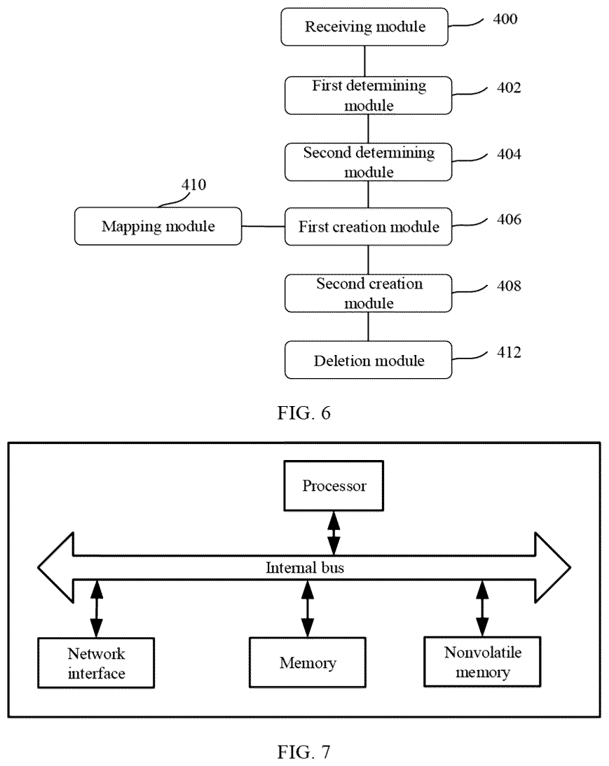

The method for creating a tablespace provided in one or more embodiments of this specification is described above. Based on the same idea, this specification further provides a corresponding apparatus for creating a tablespace, as shown in FIG. 6.

FIG. 6 is a schematic diagram illustrating an apparatus for creating a tablespace, according to this specification. The apparatus includes: a receiving module 400, configured to receive a tablespace creation instruction, where the creation instruction carries a capacity of a tablespace that needs to be created and an identifier of a server on which a storage space constituting the capacity is located; a first determining module 402, configured to determine, in the distributed database, a server corresponding to each identifier as a specified server; a second determining module 404, configured to determine, based on the capacity, a storage space whose total capacity is the capacity from a remaining storage space of each specified server; a first creation module 406, configured to create a virtual file of the capacity based on the determined storage space; and a second creation module 408, configured to create a tablespace including the virtual file, where the tablespace is used to manage the virtual file included in the tablespace, and the virtual file is used to write data.

Optionally, before creating the virtual file of the capacity, the first creation module 406 is further configured to determine that the remaining storage space of each specified server is not less than a predetermined unit capacity.

Optionally, the first creation module 406 is specifically configured to: determine, based on the capacity and a predetermined unit capacity, a specified quantity of sub-files whose sizes are all the predetermined unit capacity; circularly write each sub-file into the remaining storage space of each specified server until all the specified quantity of sub-files are written; and create the virtual file including the sub-files.

Optionally, the first creation module 406 is specifically configured to: sort each specified server to obtain a specified server sequence; for each specified server, sequentially use the specified server as a to-be-written server; determine whether a remaining storage space of the to-be-written server is not less than the unit capacity; and if yes, write the sub-file into the remaining storage space of the to-be-written server; otherwise, reuse a next specified server of the specified server as the to-be-written server based on the specified server sequence until the sub-file is written.

Optionally, the apparatus further includes a mapping module 410, configured to: for each sub-file, determine a logical address of the sub-file in the virtual file, use a specified server on which the sub-file is located as a target server, and determine a physical address of the sub-file in the target server as a physical address corresponding to the sub-file; and establish a mapping relationship between the logical address of the sub-file and the physical address corresponding to the sub-file.

Optionally, the apparatus further includes a deletion module 412, configured to: receive a deletion instruction, where the deletion instruction carries an identifier of a server that needs to be deleted; determine the server corresponding to the identifier carried in the deletion instruction as a to-be-deleted server; use each virtual file created based on a storage space of the to-be-deleted server as a to-be-deleted virtual file; for each to-be-deleted virtual file, move data in the to-be-deleted virtual file to a tablespace that does not include any to-be-deleted virtual file, and delete the to-be-deleted virtual file; and delete the identifier of the to-be-deleted server from a server identifier list of the distributed database, where the server identifier list includes identifiers of all servers constituting the distributed database.

This specification further provides a non-transitory computer-readable storage medium. The storage medium stores a computer program, and the computer program can be used to perform the above-mentioned method for creating a tablespace shown in FIG. 1.

This specification further provides a schematic structural diagram illustrating an electronic device shown in FIG. 7. As shown in FIG. 7, in terms of hardware, the electronic device includes a processor, an internal bus, a network interface, a memory, and a nonvolatile memory, and certainly can further include hardware needed by another service. The processor reads a corresponding computer program from the nonvolatile memory into the memory and then runs the computer program, to implement the above-mentioned method for creating a tablespace shown in FIG. 1. Certainly, in addition to software implementations, another implementation is not excluded in this specification, for example, a logic device or a combination of hardware and software. In other words, an execution body of the following processing process is not limited to logical units, and can be hardware or a logic device.

In the 1990s, whether a technical improvement is a hardware improvement (for example, an improvement to a circuit structure, such as a diode, a transistor, or a switch) or a software improvement (an improvement to a method procedure) can be clearly distinguished. However, with the development of technologies, improvements to many existing method procedures can be considered as direct improvements to hardware circuit structures. A designer usually programs an improved method procedure to a hardware circuit, to obtain a corresponding hardware circuit structure. Therefore, a method procedure can be improved by using a hardware entity module. For example, a programmable logic device (PLD) (for example, a field programmable gate array (FPGA)) is such an integrated circuit, and a logical function of the PLD is determined by a user through device programming. The designer performs programming to “integrate” a digital system to a PLD without requesting a chip manufacturer to design and manufacture an application-specific integrated circuit chip. In addition, instead of making an integrated circuit chip manually today, this programming is mostly implemented by using “logic compiler (logic compiler)” software. It is similar to the software compiler used in program development and writing. The original code to be compiled before is also written in a specific programming language. This is referred to as a hardware description language (Hardware Description Language, HDL), and HDL is not only one, but also many, such as ABEL (Advanced Boolean Expression Language), AHDL (Altera Hardware Description Language), Confluence, CUPL (Cornell University Programming Language), HDCal, JHDL (Java Hardware Description Language), Lava, Lola, MyHDL, PALASM, and RHDL (Ruby Hardware Description Language). Currently, VHDL (Very-High-Speed Integrated Circuit Hardware Description Language) and Verilog are most commonly used. It should also be clear to a person skilled in the art that a hardware circuit that implements a logical method procedure can be readily obtained once the method procedure is logically programmed by using the several hardware description languages described above and is programmed into an integrated circuit.

A controller can be implemented by using any appropriate method. For example, the controller can be a microprocessor or a processor, or a computer-readable medium that stores computer-readable program code (such as software or firmware) that can be executed by the microprocessor or the processor, a logic gate, a switch, an application-specific integrated circuit (ASIC), a programmable logic controller, or a built-in microprocessor. Examples of the controller include but are not limited to the following microprocessors: ARC 625D, Atmel AT91SAM, Microchip PIC18F26K20, and Silicone Labs C8051F320. The memory controller can also be implemented as a part of the control logic of the memory. A person skilled in the art also knows that, in addition to implementing the controller by using only computer-readable program code, logic programming can be performed on a method step, so the controller implements a same function in a form of a logic gate, a switch, an application-specific integrated circuit, a programmable logic controller, an embedded microcontroller, etc. Therefore, the controller can be considered as a hardware component, and an apparatus included in the controller and configured to implement various functions can also be considered as a structure in the hardware component. Or the apparatus configured to implement various functions can even be considered as both a software module implementing the method and a structure in the hardware component.

The system, apparatus, module, or unit illustrated in the previous embodiments can be implemented by using a computer chip or an entity, or can be implemented by using a product having a certain function. A typical implementation device is a computer. Specifically, for example, the computer can be a personal computer, a laptop computer, a cellular phone, a camera phone, a smartphone, a personal digital assistant, a media player, a navigation device, an email device, a game console, a tablet computer, a wearable device, or a combination of any of these devices.

For ease of description, the above-mentioned apparatus is described by dividing functions into various units. Certainly, during implementation of this specification, functions of units can be implemented in the same or more software or hardware.

A person skilled in the art should understand that the embodiments of this specification can be provided as methods, systems, or computer program products. Therefore, this specification can use a form of hardware only embodiments, software only embodiments, or embodiments with a combination of software and hardware. Moreover, a form of a computer program product implemented on one or more computer-usable storage media (including but not limited to a disk memory, a CD-ROM, an optical memory, etc.) that include computer-usable program code can be used in this specification.

This specification is described with reference to the flowcharts and/or block diagrams of the method, the device (system), and the computer program product based on the embodiments of this specification. It should be understood that computer program instructions can be used to implement each procedure and/or each block in the flowcharts and/or the block diagrams and a combination of a procedure and/or a block in the flowcharts and/or the block diagrams. These computer program instructions may be provided for a general-purpose computer, a dedicated computer, an embedded processor, or a processor of any other programmable data processing device to generate a machine, so that the instructions executed by a computer or a processor of any other programmable data processing device generate an apparatus for implementing a specific function in one or more processes in the flowcharts and/or in one or more blocks in the block diagrams.

These computer program instructions can also be stored in a computer-readable memory that can instruct a computer or another programmable data processing device to work in a specific method, so that an instruction stored in the computer-readable memory generates a manufacturer including an instruction apparatus, and the instruction apparatus implements a specific function in one or more procedures in the flowcharts and/or one or more blocks in the block diagrams.

The computer program instructions can alternatively be loaded onto a computer or another programmable data processing device, so that a series of operations and steps are performed on the computer or the another programmable device, so that computer-implemented processing is generated. Therefore, the instructions executed on the computer or the another programmable device provide steps for implementing a specific function in one or more procedures in the flowcharts and/or in one or more blocks in the block diagrams.

In a typical configuration, a computing device includes one or more processors (CPUs), one or more input/output interfaces, one or more network interfaces, and one or more memories.

The memory may include a form such as a non-permanent memory, a random access memory (RAM), or a nonvolatile memory in a computer-readable medium, for example, a read-only memory (ROM) or a flash memory (flash RAM). The memory is an example of the computer-readable medium.

Computer-readable media, including permanent and non-permanent, removable and non-removable media, can be implemented by any method or technology for information storage. The information can be computer-readable instructions, a data structure, a program module, or other data. Examples of the computer storage medium include but are not limited to a phase change random access memory (PRAM), a static random access memory (SRAM), a dynamic random access memory (DRAM), another type of random access memory (RAM), a read-only memory (ROM), an electrically erasable programmable read-only memory (EEPROM), a flash memory or another memory technology, a compact disc read-only memory (CD-ROM), a digital versatile disc (DVD) or another optical storage, a cassette magnetic tape, a magnetic tape/magnetic disk storage, another magnetic storage device, or any other non-transmission medium. The computer storage medium can be configured to store information that can be accessed by a computing device. Based on the definition in this specification, the computer-readable medium does not include transitory computer-readable media such as a modulated data signal and carrier.

It is further worthwhile to note that the terms “include”, “comprise”, or any other variants thereof are intended to cover a non-exclusive inclusion, so that a process, a method, a product, or a device that includes a list of elements not only includes those elements but also includes other elements which are not expressly listed, or further includes elements inherent to such a process, method, product, or device. Without more constraints, an element preceded by “includes a . . . ” does not preclude the presence of additional identical elements in the process, method, product, or device that includes the element.

A person skilled in the art should understand that the embodiments of this specification can be provided as methods, systems, or computer program products. Therefore, this specification can use a form of hardware only embodiments, software only embodiments, or embodiments with a combination of software and hardware. Moreover, a form of a computer program product implemented on one or more computer-usable storage media (including but not limited to a disk memory, a CD-ROM, an optical memory, etc.) that include computer-usable program code can be used in this specification.

This specification can be described in a general context of a computer-executable instruction executed by a computer, for example, a program module. Generally, the program module includes a routine, a program, an object, a component, a data structure, etc. for executing a specific task or implementing a specific abstract data type. This specification can alternatively be practiced in distributed computing environments. In the distributed computing environments, tasks are executed by remote processing devices connected through a communication network. In the distributed computing environment, a program module can be located in local and remote computer storage media including a storage device.

The embodiments of this specification are described in a progressive method. For same or similar parts in the embodiments, refer to each other. Each embodiment focuses on a difference from other embodiments. Particularly, the system embodiments are basically similar to the method embodiments, and therefore are briefly described. For a related part, refer to some descriptions in the method embodiments.

The above-mentioned descriptions are the embodiments of this specification and are not intended to limit this specification. A person skilled in the art can make various changes and variations to this specification. Any modification, equivalent replacement, or improvement made without departing from the spirit and principle of this specification shall fall within the scope of the claims in this specification.

1. A method for creating a tablespace, wherein the method is applied to a distributed database, and the method comprises:
receiving a tablespace creation instruction, wherein the creation instruction carries a capacity of a tablespace that needs to be created and an identifier of a server on which a storage space constituting the capacity is located;
determining, in the distributed database, a server corresponding to each identifier as a specified server;
determining, based on the capacity, a storage space whose total capacity is the capacity from a remaining storage space of each specified server;
creating a virtual file of the capacity based on a determined storage space; and
creating a tablespace comprising the virtual file, wherein the tablespace is used to manage the virtual file comprised in the tablespace, and the virtual file is used to write data.

2. The method according to claim 1, before the creating a virtual file of the capacity, the method comprises:
determining that the remaining storage space of each specified server is not less than a predetermined unit capacity.

3. The method according to claim 1, wherein the creating a virtual file of the capacity based on a determined storage space comprises:
determining, based on the capacity and a predetermined unit capacity, a specified quantity of sub-files whose sizes are all the predetermined unit capacity;
circularly writing each sub-file into the remaining storage space of each specified server until all the specified quantity of sub-files are written; and
creating the virtual file comprising the sub-files.

4. The method according to claim 3, wherein the circularly writing each sub-file to the remaining storage space of each specified server specifically comprises:
sorting each specified server to obtain a specified server sequence;
for each specified server, sequentially using the specified server as a to-be-written server;
determining whether a remaining storage space of the to-be-written server is not less than the unit capacity; and
upon determining that the remaining storage space of the to-be-written server is not less than the unit capacity, writing the sub-file into the remaining storage space of the to-be-written server;
upon determining that the remaining storage space of the to-be-written server is less than the unit capacity, reusing a next specified server of the specified server as the to-be-written server based on the specified server sequence until the sub-file is written.

5. The method according to claim 3, wherein the method further comprises:
for each sub-file, determining a logical address of the sub-file in the virtual file, using a specified server on which the sub-file is located as a target server, and determining a physical address of the sub-file in the target server as a physical address corresponding to the sub-file; and
establishing a mapping relationship between the logical address of the sub-file and the physical address corresponding to the sub-file.

6. The method according to claim 1, wherein the method further comprises:
receiving a deletion instruction, wherein the deletion instruction carries an identifier of a server that needs to be deleted;
determining the server corresponding to the identifier carried in the deletion instruction as a to-be-deleted server;
using each virtual file created based on a storage space of the to-be-deleted server as a to-be-deleted virtual file;
for each to-be-deleted virtual file, moving data in the to-be-deleted virtual file to a tablespace that does not comprise any to-be-deleted virtual file, and deleting the to-be-deleted virtual file; and
deleting the identifier of the to-be-deleted server from a server identifier list of the distributed database, wherein the server identifier list comprises identifiers of all servers constituting the distributed database.

7-12. (canceled)

13. A non-transitory computer-readable storage medium, wherein the storage medium stores a computer program; and when the computer program is executed by a processor, the processor is caused to implement a method for creating a tablespace, wherein the method is applied to a distributed database, and the method comprises:
receiving a tablespace creation instruction, wherein the creation instruction carries a capacity of a tablespace that needs to be created and an identifier of a server on which a storage space constituting the capacity is located;
determining, in the distributed database, a server corresponding to each identifier as a specified server;
determining, based on the capacity, a storage space whose total capacity is the capacity from a remaining storage space of each specified server;
creating a virtual file of the capacity based on a determined storage space; and
creating a tablespace comprising the virtual file, wherein the tablespace is used to manage the virtual file comprised in the tablespace, and the virtual file is used to write data.

14. An electronic device, comprising a memory, a processor, and a computer program stored in the memory and capable of running on the processor, wherein when the processor executes the computer program, the processor is caused to implement a method for creating a tablespace, wherein the method is applied to a distributed database, and the method comprises:
receiving a tablespace creation instruction, wherein the creation instruction carries a capacity of a tablespace that needs to be created and an identifier of a server on which a storage space constituting the capacity is located;
determining, in the distributed database, a server corresponding to each identifier as a specified server;
determining, based on the capacity, a storage space whose total capacity is the capacity from a remaining storage space of each specified server;
creating a virtual file of the capacity based on a determined storage space; and
creating a tablespace comprising the virtual file, wherein the tablespace is used to manage the virtual file comprised in the tablespace, and the virtual file is used to write data.

15. The non-transitory computer-readable storage medium according to claim 13, before the creating a virtual file of the capacity, the processor is further caused to:
determining that the remaining storage space of each specified server is not less than a predetermined unit capacity.

16. The non-transitory computer-readable storage medium according to claim 15, wherein the creating a virtual file of the capacity based on a determined storage space comprises:
determining, based on the capacity and a predetermined unit capacity, a specified quantity of sub-files whose sizes are all the predetermined unit capacity;
circularly writing each sub-file into the remaining storage space of each specified server until all the specified quantity of sub-files are written; and
creating the virtual file comprising the sub-files.

17. The non-transitory computer-readable storage medium according to claim 15, wherein the circularly writing each sub-file to the remaining storage space of each specified server specifically comprises:
sorting each specified server to obtain a specified server sequence;
for each specified server, sequentially using the specified server as a to-be-written server;
determining whether a remaining storage space of the to-be-written server is not less than the unit capacity; and
upon determining that the remaining storage space of the to-be-written server is not less than the unit capacity, writing the sub-file into the remaining storage space of the to-be-written server;
upon determining that the remaining storage space of the to-be-written server is less than the unit capacity, reusing a next specified server of the specified server as the to-be-written server based on the specified server sequence until the sub-file is written.

18. The non-transitory computer-readable storage medium according to claim 15, the processor is further caused to:
for each sub-file, determining a logical address of the sub-file in the virtual file, using a specified server on which the sub-file is located as a target server, and determining a physical address of the sub-file in the target server as a physical address corresponding to the sub-file; and
establishing a mapping relationship between the logical address of the sub-file and the physical address corresponding to the sub-file.

19. The non-transitory computer-readable storage medium according to claim 13, wherein the electronic device is further caused to:
receiving a deletion instruction, wherein the deletion instruction carries an identifier of a server that needs to be deleted;
determining the server corresponding to the identifier carried in the deletion instruction as a to-be-deleted server;
using each virtual file created based on a storage space of the to-be-deleted server as a to-be-deleted virtual file;
for each to-be-deleted virtual file, moving data in the to-be-deleted virtual file to a tablespace that does not comprise any to-be-deleted virtual file, and deleting the to-be-deleted virtual file; and
deleting the identifier of the to-be-deleted server from a server identifier list of the distributed database, wherein the server identifier list comprises identifiers of all servers constituting the distributed database.

20. The electronic device according to claim 14, before the creating a virtual file of the capacity, the electronic device is further caused to:
determining that the remaining storage space of each specified server is not less than a predetermined unit capacity.

21. The electronic device according to claim 14, wherein the creating a virtual file of the capacity based on a determined storage space comprises:
determining, based on the capacity and a predetermined unit capacity, a specified quantity of sub-files whose sizes are all the predetermined unit capacity;
circularly writing each sub-file into the remaining storage space of each specified server until all the specified quantity of sub-files are written; and
creating the virtual file comprising the sub-files.

22. The electronic device according to claim 21, wherein the circularly writing each sub-file to the remaining storage space of each specified server specifically comprises:
sorting each specified server to obtain a specified server sequence;
for each specified server, sequentially using the specified server as a to-be-written server;
determining whether a remaining storage space of the to-be-written server is not less than the unit capacity; and
upon determining that the remaining storage space of the to-be-written server is not less than the unit capacity, writing the sub-file into the remaining storage space of the to-be-written server;
upon determining that the remaining storage space of the to-be-written server is less than the unit capacity, reusing a next specified server of the specified server as the to-be-written server based on the specified server sequence until the sub-file is written.

23. The electronic device according to claim 21, the electronic device is further caused to:
for each sub-file, determining a logical address of the sub-file in the virtual file, using a specified server on which the sub-file is located as a target server, and determining a physical address of the sub-file in the target server as a physical address corresponding to the sub-file; and
establishing a mapping relationship between the logical address of the sub-file and the physical address corresponding to the sub-file.

24. The electronic device according to claim 14, wherein the electronic device is further caused to:
receiving a deletion instruction, wherein the deletion instruction carries an identifier of a server that needs to be deleted;
determining the server corresponding to the identifier carried in the deletion instruction as a to-be-deleted server;
using each virtual file created based on a storage space of the to-be-deleted server as a to-be-deleted virtual file;
for each to-be-deleted virtual file, moving data in the to-be-deleted virtual file to a tablespace that does not comprise any to-be-deleted virtual file, and deleting the to-be-deleted virtual file; and
deleting the identifier of the to-be-deleted server from a server identifier list of the distributed database, wherein the server identifier list comprises identifiers of all servers constituting the distributed database.
